(19) United States
(12) Patent Application Publication
(10) Pub. No.: US 2020/0189233 A1
(43) Pub. Date: Jun. 18, 2020

(54) HOT STAMPED MEMBER

(71) Applicant: NIPPON STEEL CORPORATION, Tokyo (JP)

(72) Inventors: Yuki SUZUKI, Tokyo (JP); Soshi FUJITA, Tokyo (JP); Jun MAKI, Tokyo (JP); Kazuhisa KUSUMI, Tokyo (JP); Masahiro FUDA, Tokyo (JP); Hideaki IRIKAWA, Tokyo (JP)

(73) Assignee: NIPPON STEEL CORPORATION, Tokyo (JP)

(21) Appl. No.: 16/617,899

(22) PCT Filed: Jun. 1, 2018
(86) PCT No.: PCT/JP2018/021254

§ 371 Date: Nov. 27, 2019

(30) Foreign Application Priority Data
Jun. 2, 2017 (JP) 2017-110212

(51) Int. Cl. B32B 15/01; C23C 28/00; C22C 38/04; C23C 2/40; C22C 38/02; C22C 38/06; C22C 38/28

(52) U.S. Cl. CPC B32B 15/012; C23C 28/345; C22C 38/04; B32B 2309/105; C22C 38/02; C22C 38/06; C22C 38/28; C23C 2/40

(57) ABSTRACT

A hot stamped member has a steel, an Al—Fe intermetallic compound layer formed on the steel, and an oxide film layer formed on the Al—Fe intermetallic compound layer, in which the oxide film layer is made up of one or more A group elements selected from the group consisting of Be, Mg, Ca, Sr, Ba, Sc, Ti, V, Cr, Mn, Fe, Co, Ni, Cu, and Zn, Al, oxygen, and impurities, a proportion of the A group element in the oxide film layer excluding the oxygen is 0.01 atom % or more and 80 atom % or less, a thickness t of the oxide film layer is 0.1 to 10.0 μm, and, in the case of measuring the A group element in the oxide film layer in a thickness direction from a surface of the oxide film layer using a GDS, a maximum value of a detection intensity of the A group element in a range from the surface to one-third of the thickness t is 3.0 times or more an average value of detection intensities of the A group element in a range from two thirds of the thickness t to t.

### TECHNICAL FIELD OF THE INVENTION

The present invention relates to a hot stamped member.

Priority is claimed on Japanese Patent Application No. 2017-110212, filed in Japan, Jun. 2, 2017, the content of which is incorporated herein by reference.

### RELATED ART

In recent years, there has been rising demand for suppressing the consumption of chemical fuels for the sake of environmental protection and the prevention of global warming, and this demand affects a variety of manufacturing industries. For example, cars, which are an indispensable unit of transportation in our daily lives and activities, are no exception to this demand, and there is demand for improvement in gas mileage and the like through weight reduction of vehicle bodies and the like. However, for a car, there is a possibility that simply reducing the weight of a vehicle body may lead to degradation of safety, which is not permissible in terms of product quality. Therefore, in the case of reducing the weight of a vehicle body, it is necessary to ensure appropriate safety.

The majority of the structure of a car is formed of iron, particularly, steel sheets, and reduction of the weight of the steel sheets is important in the weight reduction of a vehicle body. In addition, demand for such steel sheets has risen not only in the car-manufacturing industry but also in a variety of manufacturing industries. As a method for simply reducing the weight of steel sheets to satisfy the above-described demand, the reduction of the sheet thickness of the steel sheets can be considered. However, the reduction of the sheet thickness of steel sheets leads to a decrease in the strength of a structure. Therefore, in recent years, research and development has been underway regarding steel sheets capable of maintaining or increasing the mechanical strength of structures configured using the steel sheets even when thinned more than steel sheets that have been thus far used by increasing the mechanical strength of the steel sheets.

Generally, materials having a high mechanical strength tend to degrade in shape fixability during forming such as bending. Therefore, in the case of working a material into a complex shape, working itself becomes difficult. As one method for solving this problem regarding formability, a so-called “hot stamping method (a hot pressing method, a hot pressing method, a high-temperature pressing method, or a die quenching method)” is exemplified. In this hot stamping method, a material that is a forming subject is heated to a high temperature, and a steel sheet softened by heating is formed by pressing and cooled after being formed. According to this hot stamping method, the material is softened after being heated to a high temperature once, and thus the material can be readily pressed. Furthermore, the mechanical strength of the material can be increased by the quenching effect of the cooling after forming. Therefore, a formed article having favorable shape fixability and a high mechanical strength can be obtained by this hot stamping method.

However, in the case of applying this hot stamping method to steel sheets, for members and the like requiring corrosion resistance, it is necessary to carry out an antirust treatment on the surface of a formed member or coat the surface with a metal. Therefore, a surface cleaning step, a surface treatment step, and the like become necessary, and the productivity degrades.

With respect to such a problem, Patent Document 1 describes an aluminum-based plated steel sheet for hot stamping containing Al as a main body in a surface of steel and having an Al-based metal coating containing Mg and Si.

Patent Document 2 regulates a composition of a surface of a steel sheet for hot stamping and describes that an amount of AlN in a surface of an Al—Fe alloy layer on a surface of steel is 0.01 to 1 g/m².

Patent Document 3 describes a vehicle member having an Al—Fe intermetallic compound layer on a surface of a steel, further having an oxide film on a surface of the Al—Fe intermetallic compound layer, and having a bcc layer having Al between the steel and the Al—Fe intermetallic compound layer and describes a film thickness of the oxide film on the surface of a hot stamped Al—Fe alloy layer. It describes that the Al—Fe alloy layer is formed up to a surface layer by heating the aluminum-plated steel sheet so that the oxide film has a predetermined thickness and corrosion resistance after coating is ensured by suppressing coating film defects or the degradation of adhesion after electrodeposition coating.

However, the aluminum-plated steel sheet for hot stamping described in Patent Document 1 does not have sufficient corrosion resistance after hot stamping and coating. In addition, there is no regulation regarding a composition or structure of an outermost surface, and a relationship between the composition or structure of the outermost surface and the corrosion resistance after coating is not clarified.

In Patent Document 2, the corrosion resistance after coating is improved to a certain extent by setting the amount of AlN in the surface of the Al—Fe alloy layer to a predetermined range, but there is room for additional improvement.

As described in Patent Document 3, the corrosion resistance after coating is not sufficient even when the structure or thickness of the Al—Fe alloy layer is controlled. The reason therefor may be a decrease in the adhesion amount of a chemical conversion treatment agent due to the degradation of the reactivity between the oxide film and the chemical conversion treatment agent or the like.

In addition, in order to ensure the mechanical strength of the steel sheet, it is necessary to suppress the occurrence of pitting corrosion caused by the propagation of corrosion in a thickness direction in a part of the steel sheet. However, in the steel sheets described in these documents, there is no sufficient countermeasure to pitting corrosion.

### PRIOR ART DOCUMENT

### Patent Document

[Patent Document 1] Japanese Unexamined Patent Application, First Publication No. 2003-034845

[Patent Document 2] Japanese Unexamined Patent Application, First Publication No. 2011-137210

[Patent Document 3] Japanese Unexamined Patent Application, First Publication No. 2009-293078

### DISCLOSURE OF THE INVENTION

### Problems to be Solved by the Invention

As described above, in the related art, there has been a problem in that it is not possible to sufficiently ensure the corrosion resistance after coating or pitting corrosion resistance of hot stamped members.

The present invention has been made in consideration of the above-described problem, and an object of the present invention is to provide a hot stamped member that has excellent coating material adhesiveness having a significant influence on corrosion resistance after coating and pitting corrosion resistance.

### Means for Solving the Problem

In a case where a hot stamped member is used for, for example, a vehicle component, in a step of manufacturing a car, a chemical conversion film of zinc phosphate or the like, which serves as a base material of an electrodeposition coating film, is formed, and a resin coating film (electrodeposition coating film) is formed on the chemical conversion film. In order to enhance the adhesion of a coating material (electrodeposition coating film), it is useful to increase the amount of zinc phosphate crystals precipitated in the chemical conversion film of zinc phosphate or the like which is a base material film of a resin-based coating film. In a chemical conversion treatment step, when the concentration of zinc phosphate in a zinc phosphate aqueous solution exceeds the solubility of zinc phosphate, zinc phosphate crystals are precipitated. Here, the solubility of zinc phosphate decreases as the pH of the zinc phosphate aqueous solution increases.

The present inventors found that, in the chemical conversion treatment step, when an element forming an oxide that brings about an increase in pH when dissolved in water, that is, an element belonging to Group II of the periodic table, and a four-period d block element are added to an oxide film layer present on the surface of a hot stamped member in a predetermined amount in order to increase the pH on the surface of the hot stamped member, the coating material adhesiveness improves.

In addition, it was also found that the addition of the above-described element to the oxide film layer enhances the coating material adhesiveness, but there are cases where the pitting corrosion resistance is not always sufficient. As a result of additional studies, the present inventors found that the distribution state of the above-described element in the oxide film layer has an influence on the pitting corrosion resistance.

The present invention has been made in consideration of the above-described finding. The overview of the present invention is as described below.

[1] A hot stamped member according to an aspect of the present invention having a steel, an Al—Fe intermetallic compound layer formed on the steel, and an oxide film layer formed on the Al—Fe intermetallic compound layer, in which the oxide film layer includes one or more A group elements selected from the group consisting of Be, Mg, Ca, Sr, Ba, Sc, Ti, V, Cr, Mn, Fe, Co, Ni, Cu, and Zn, Al, oxygen, and impurities, a proportion of the A group element in the oxide film layer excluding the oxygen is 0.01 atom % or more and 80 atom % or less, a thickness t of the oxide film layer is 0.1 to 10.0 nm, and, in the case of measuring the A group element in the oxide film layer in a thickness direction from a surface using a GDS, a maximum value of a detection intensity of the A group element in a range from the surface to one-third of the thickness t is 3.0 times or more an average value of detection intensities of the A group element in a range from two thirds of the thickness t to t.

[2] The hot stamped member according to [1], in which the maximum value of the detection intensity of the A group element may be 8.0 times or more the average value of the detection intensities of the A group element.

[3] The hot stamped member according to [1] or [2], in which a component of the steel may include, by mass %, C: 0.1% to 0.4%, Si: 0.01% to 0.60%, Mn: 0.50% to 3.00%, P: 0.05% or less, S: 0.020% or less, Al: 0.10% or less, Ti: 0.01% to 0.10%, B: 0.0001% to 0.0100%, N: 0.010% or less, Cr: 0% to 1.0%, and Mo: 0% to 1.0% with a remainder of Fe and impurities.

[4] The hot stamped member according to [3], in which the component of the steel may include, by mass %, any one or both of Cr: 0.01% to 1.0% and Mo: 0.01% to 1.0%.

[5] The hot stamped member according to any one of [1] to [4], in which the Al—Fe intermetallic compound layer may include Si.

### Effects of the Invention

According to the present invention, it is possible to provide a hot stamped member that has excellent adhesion to electrodeposition coating films (coating material adhesiveness) and pitting corrosion resistance. This hot stamped member has excellent corrosion resistance after coating.

### BRIEF DESCRIPTION OF THE DRAWINGS

FIG. 1 is a cross-sectional schematic view of a hot stamped member according to the present embodiment.

FIG. 2 is a graph showing a relationship between an amount of zinc phosphate crystals precipitated and a proportion of an A group element in an oxide film layer.

FIG. 3 is a graph showing a relationship between the amount of the zinc phosphate crystals precipitated and coating material adhesiveness.

FIG. 4 is a graph showing a relationship between the coating material adhesiveness and the proportion of the A group element in the oxide film layer.

FIG. 5 is a graph showing a relationship between the coating material adhesiveness and a thickness of the oxide film layer.

FIG. 6 is a schematic view showing an example of a method for manufacturing the hot stamped member.

FIG. 7A is a view showing an example of a distribution state of the A group element (Mg) in the hot stamped member according to the present embodiment, which is measured using a GDS.

FIG. 7B is a view showing an example of a distribution state of the A group element (Mg) in comparative steel, which is measured using a GDS.

### EMBODIMENTS OF THE INVENTION

Hereinafter, a preferred embodiment of the present invention will be described in detail.

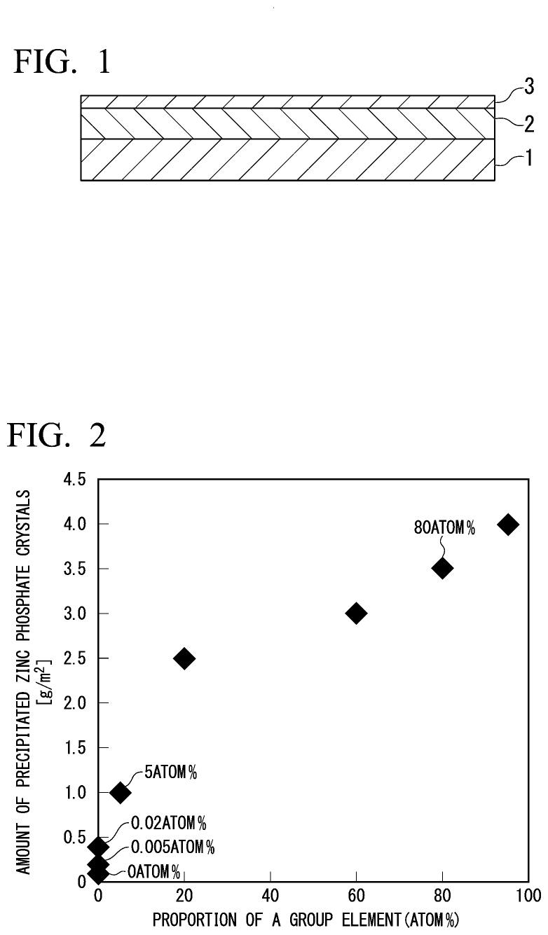

FIG. 1 shows a cross-sectional schematic view of a hot stamped member according to the present embodiment. FIG. 1 is a schematic view for helping the understanding of a laminate structure of individual layers. The hot stamped member according to the present embodiment has a steel 1, an Al—Fe intermetallic compound layer 2 formed on the steel 1, and an oxide film layer 3 formed on the Al—Fe intermetallic compound layer 2.

The oxide film layer 3 is made up of one or more A group elements of elements belonging to Group II of the periodic table or four-period d block elements, Al, oxygen, and impurities. The elements belonging to Group II of the periodic table are Be, Mg, Ca, Sr, and Ba, and the four-period d block elements are Sc, Ti, V, Cr, Mn, Fe, Co, Ni, Cu, and Zn. As the A group elements, one or more of these elements are included in the oxide film layer 3.

In addition, the proportion of the A group element to all elements excluding oxygen in the oxide film layer 3 is set to 0.01 atom % or more and 80 atom % or less.

Furthermore, the thickness of the oxide film layer 3 is in a range of 0.1 to 10.0 μm.

In addition, the maximum value of the detection intensity of the A group element in a range from the surface of the oxide film layer 3 to ⅓t (t represents the thickness of the oxide film layer) is 3.0 times or more the average value of the detection intensities of the A group element in a range from 2t/3 to t from the surface.

In the hot stamped member according to the present embodiment, the A group element is included in the oxide film layer 3 that is the outermost layer. The A group element is included in the oxide film layer 3 mainly in an oxide form. When a chemical conversion treatment is carried out on the outermost surface (oxide film layer) of the above-described hot stamped member, the presence of the oxide of the A group element increases the pH of a chemical conversion treatment liquid in the interface between the oxide film layer and the chemical conversion treatment liquid and thus increases the amount of zinc phosphate crystals precipitated. That is, so-called chemical convertibility is enhanced. In addition, consequently, the adhesion of an electrodeposition coating film that is electrodeposition-coated after the chemical conversion treatment improves. The enhancement of the adhesion of the electrodeposition coating film improves corrosion resistance after coating.

In addition, the A group element is concentrated in the surface layer of the oxide film layer 3. As a result, pitting corrosion resistance also improves.

Hereinafter, the Al—Fe intermetallic compound layer 2, the oxide film layer 3, and the steel 1 that configure the hot stamped member according to the present embodiment will be described.

(Al—Fe Intermetallic Compound Layer 2)

The Al—Fe intermetallic compound layer 2 is formed in contact with a surface of the steel 1. In the Al—Fe intermetallic compound layer 2, Al, Fe, and impurities are included. In addition, in the Al—Fe intermetallic compound layer 2, Si may be included, and the A group element to be described below may be included. More specifically, the Al—Fe intermetallic compound layer 2 is made up of Al, Fe, and impurities and may also include Si and/or the A group element.

In addition, in the metallographic structure of the Al—Fe intermetallic compound layer 2, one or both of an Al—Fe alloy phase or an Al—Fe—Si alloy phase is included.

The Al—Fe intermetallic compound layer 2 is formed by subjecting an aluminum-plated steel to a hot stamping step. The aluminum-plated steel which serves as a raw sheet is a steel having an Al plating layer including aluminum or an aluminum alloy. In the hot stamping step, the Al plating layer melts by being heated to a melting point or higher, at the same time, Fe and Al mutually diffuse between the steel 1 and the Al plating layer, and an Al phase in the Al plating layer changes to the Al—Fe alloy phase, whereby the Al—Fe intermetallic compound layer 2 is formed. In a case where Si is included in the Al plating layer, the Al phase in the Al plating layer also changes to an Al—Fe—Si alloy phase. The melting points of the Al—Fe alloy phase and the Al—Fe—Si alloy phase are approximately 1,150° C. and higher than the upper limit of the heating temperature of an ordinary hot stamping step, and thus the formation of the alloy phase leads to the precipitation of the alloy phase on the surface of the steel and the formation of the Al—Fe intermetallic compound layer 2. There are a plurality of kinds of the Al—Fe alloy phase and the Al—Fe—Si alloy phase, and when heated at a high temperature or heated for a long period of time, the Al—Fe alloy phase and the Al—Fe—Si alloy phase change to an alloy phase having a higher concentration of Fe. In addition, in a case where the A group element is included in the Al—Fe intermetallic compound layer 2, the A group element can be present in a variety of forms such as an intermetallic compound, a solid solution, and the like.

The thickness of the Al—Fe intermetallic compound layer 2 is preferably in a range of 0.1 to 10.0 μm and more preferably in a range of 0.5 to 3.0 μm. When the thickness of the Al—Fe intermetallic compound layer 2 is set to 0.1 μm or more, it is possible to improve the corrosion resistance of the hot stamped member. In addition, when the thickness of the Al—Fe intermetallic compound layer 2 is set to 10.0 μm or less, it is possible to prevent the cracking of the Al—Fe intermetallic compound layer. Here, the thickness of the Al—Fe intermetallic compound layer 2 can be specified by subtracting the thickness of the oxide film layer 3 from the thickness from the interface between the Al—Fe intermetallic compound layer 2 and the steel 1 to a surface of the oxide film layer 3. The interface between the Al—Fe intermetallic compound layer 2 and the steel 1 can be specified by, for example, observing the cross sections of the Al—Fe intermetallic compound layer 2 and the steel 1 using a scanning electron microscope. In addition, the thickness of the oxide film layer can be measured using a method to be described below.

In addition, in the Al—Fe intermetallic compound layer 2, the particles of a nitride, a carbide, and an oxide such as titanium nitride, silicon nitride, titanium carbide, silicon carbide, titanium oxide, silicon oxide, iron oxide, and/or aluminum oxide may be included. These particles are added thereto in order to make the A group element to be included the oxide film layer. These particles do not have any direct influence on the adhesion to an electrodeposition coating film even when present in the Al—Fe intermetallic compound layer 2.

(Oxide Film Layer 3)

The oxide film layer 3 is formed as an outermost surface layer of the hot stamped member on a front surface side (a side opposite to the steel 1) of the hot stamped member of the Al—Fe intermetallic compound layer 2. The oxide film layer 3 is generated by the oxidation of the surface layer of the Al plating layer of the aluminum-plated steel in a heating process of hot stamping at the time of manufacturing the hot stamped member. The oxide film layer 3 is made up of the A group element, Al, oxygen, and impurities. In the oxide film layer 3, furthermore, any one or both of Fe or Si may be included. A part of Fe and Si contained in the Al—Fe intermetallic compound layer 2 are mixed into the oxide film layer in some cases during the formation of the oxide film layer 3.

The composition of these elements in the oxide film layer 3 can be quantified from a cross section using an electron probe micro-analyzer (EPMA), a transmission electron microscope (TEM), a glow discharge spectrometer (GDS), or the like. The oxide film layer 3 including the A group element improves the chemical convertibility (phosphate treatment property) of the hot stamped member as will be described below.

The A group element included in the oxide film layer 3 is an element belonging to Group II or a four-period d block element of the periodic table. In the present embodiment, the elements belonging to Group II of the periodic table are Be, Mg, Ca, Sr, and Ba, and the four-period d block elements are Sc, Ti, V, Cr, Mn, Fe, Co, Ni, Cu, and Zn. The oxide film layer 3 in the hot stamped member according to the present embodiment needs to include one or more of the above-described elements. As the A group element, some of the A group element may be present in the form of an element single body or a compound other than an oxide, but is preferably present in the form of an oxide in the oxide film layer 3. It is more preferable for almost all (for example, 90% or more) of the A group element in the oxide film layer 3 to be present in the form of an oxide. The A group element is preferably present in the form of MAl₂O₄ (M represents the A group element). Although the mechanism is not clear, when the A group element is in the form of MAl₂O₄, the pitting corrosion resistance improves.

In the oxide film layer 3, elements other than the A group element are also preferably present in the state of an oxide. For example, it is preferable for Al to be present as aluminum oxide and for other impurities to be present as oxides of the respective impurities. In addition, in a case where Si is included in the oxide film layer, Si is preferably present as silicon oxide, and in a case where Fe is included, Fe is preferably present as iron oxide. In addition, each of the A group element, Al, Si, and Fe may be included in the form of a complex oxide with other elements.

The oxide of the A group element is classified as a basic oxide. In a chemical conversion treatment step, some of a basic oxide including the A group element in an oxide film is dissolved upon coming into contact with a phosphoric acid chemical conversion treatment liquid (hereinafter referred to as the chemical conversion treatment liquid) and increases the pH of a solution in an interface between the chemical conversion treatment liquid and the oxide film layer. Meanwhile, when the pH increases, the solubility of zinc phosphate included in the chemical conversion treatment liquid decreases, and the amount of crystal being precipitated increases. Therefore, an increase in the pH in the interface between the surface of the oxide film layer and the chemical conversion treatment liquid increases zinc phosphate crystals being precipitated on the surface of the oxide film layer.

In the case of improving the coating material adhesiveness by increasing the amount of zinc phosphate crystals precipitated in the chemical conversion treatment, the proportion of the A group element to all of the elements excluding oxygen in the oxide film layer 3 is 0.01 atom % or more and 80 atom % or less. In addition, the thickness of the oxide film layer 3 is in a range of 0.01 to 10.0 μm.

In a case where the proportion of the A group element in the oxide film layer 3 and the thickness of the oxide film layer are as described above, it is possible to precipitate a number of zinc phosphate crystals in the chemical conversion treatment step. Hereinafter, the reasons for limiting the proportion of the A group element and the thickness of the oxide film layer 3 for improving the coating material adhesiveness by increasing the amount of zinc phosphate crystals precipitated in the chemical conversion treatment will be described.

The amount of zinc phosphate crystals precipitated in the case of carrying out a chemical conversion treatment on the surface of the oxide film layer 3 in the hot stamped member according to the present embodiment is desirably 0.3 g/m² to 3.0 g/m². When the amount of zinc phosphate crystals precipitated is small, protrusions and recesses on the surface of the chemical conversion-treated film become relatively small, and zinc phosphate crystals capable of chemically and physically bonding to a resin-based coating film or the surface area of the oxide film layer decrease. Therefore, the coating material adhesiveness is insufficient. On the other hand, when the amount of zinc phosphate crystals precipitated is too large, the surface area of zinc phosphate crystals capable of bonding to the resin-based coating film increases, but it becomes easy for the zinc phosphate crystals to be exfoliated from the surface of the oxide film layer. Therefore, the coating material adhesiveness is insufficient.

In addition, the pH in the interface between the surface of the oxide film layer and the chemical conversion treatment liquid during the chemical conversion treatment desirably becomes 6 to 10. When the pH is lower than 6, the amount of zinc phosphate crystals precipitated decreases, and when the pH is higher than 10, the amount of zinc phosphate crystals precipitated excessively increases.

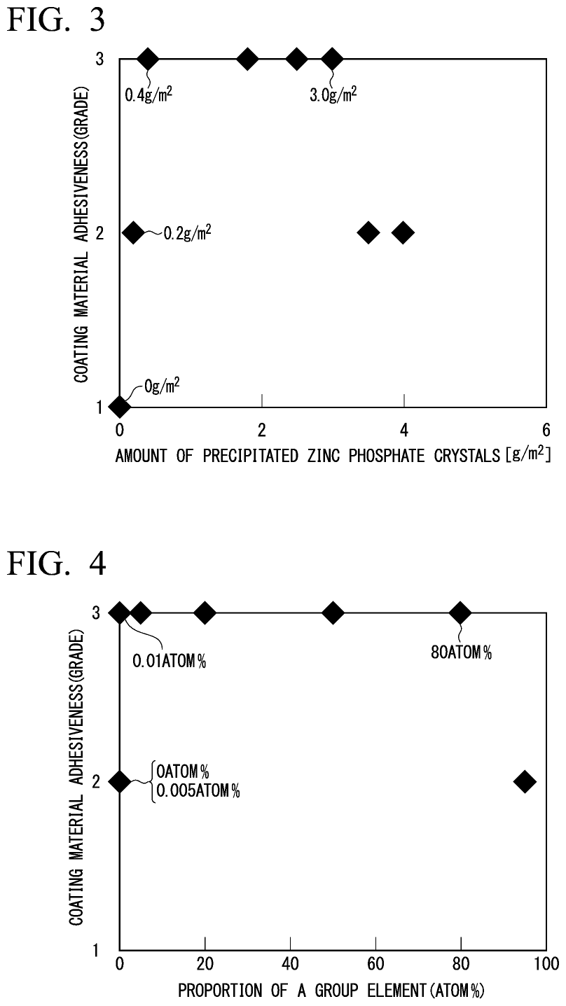

The relationship between the proportion of the A group element in the oxide film layer excluding oxygen and the amount of zinc phosphate crystals precipitated is shown in FIG. 2. In addition, the relationship between the amount of zinc phosphate crystals precipitated and the coating material adhesiveness is shown in FIG. 3. The proportion of the A group element in the oxide film layer in FIG. 2 is the amount proportion (atom %) of an A element in the amount of all of the elements excluding oxygen among the elements configuring the oxide film layer. Regarding the criterion for the grading of the coating material adhesiveness in FIG. 3, the coating material adhesiveness is graded as follows: a mark is inscribed on a sample coated with an electrodeposition coating film in a grid shape using a cutter knife across a 10 mm×10 mm area at intervals of 1 mm, the sample is immersed in warm water (60° C.) for 2,000 hours, and then the coating material adhesiveness is graded on the basis of the area ratio of exfoliated portions. Grades 3, 2, and 1 indicate that the exfoliated areas are 0% or more and less than 10%, 10% or more and less than 70%, and 70% to 100%, respectively. In addition, individual plots shown in FIG. 2 and FIG. 3 indicate the testing results of the same sample. In this sample, Sr is used as the A group element.

As shown in FIG. 2, it is found that, as the proportion of the A group element in the oxide film layer increases, the amount of zinc phosphate crystals precipitated increases. In addition, as shown in FIG. 3, it is found that, when the amount of zinc phosphate crystals precipitated in the chemical conversion-treated film is 0.2 g/m² or less, the grade becomes 2 or less. Furthermore, it is found that, when the amount of zinc phosphate crystals precipitated in the chemical conversion-treated film exceeds 3.0 g/m², the grade decreases.

The relationship between the proportion of the A group element in the oxide film layer excluding oxygen and the coating material adhesiveness is shown in FIG. 4. Sr is used as the A group element. The criteria for the grading of the coating material adhesiveness in FIG. 4 are the same as those in the case of FIG. 3. As shown in FIG. 4, in a case where the proportion of the A group element is less than 0.01 atom %, the pH does not easily increase in the interface with the chemical conversion treatment liquid, the amount of zinc phosphate crystals precipitated decreases, and the coating material adhesiveness of the electrodeposition coating film deteriorates. On the other hand, when the proportion of the A group element exceeds 80 atom %, the amount of zinc phosphate crystals precipitated excessively increases, and the coating material adhesiveness deteriorates.

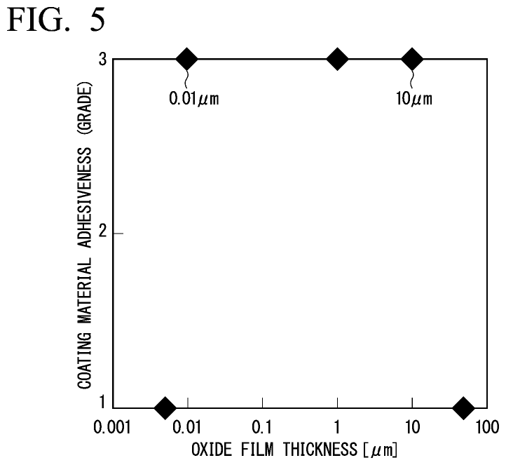

The relationship between the thickness of the oxide film layer and the coating material adhesiveness is shown in FIG. 5. The oxide film layer shown in FIG. 5 is a film including Sr as the A element. As shown in FIG. 5, it is found that, in a case where the thickness of the oxide film layer is less than 0.01 μm, the amount of an oxide contributing to an increase in the pH in the interface with the chemical conversion treatment liquid in the chemical conversion treatment step is small, and thus the amount of zinc phosphate crystals precipitated is small, and the coating material adhesiveness of the electrodeposition coating film is insufficient. In addition, it is found that, when the thickness of the oxide film layer is thicker than 10.0 μm, it becomes easy for the oxide film layer to be exfoliated from the plated interface, and thus the coating material adhesiveness of the electrodeposition coating film is insufficient.

The tendencies shown in FIG. 1 to FIG. 5 show the same behaviors even in a case where the A group element is changed to an element other than Sr.

From what has been described above, it is found that, in a case where the proportion of the A group element in the oxide film layer excluding oxygen is 0.01 atom % or more and 80 atom % or less, and the thickness of the oxide film layer is 0.01 to 10.0 μm, it is possible to form a chemical conversion-treated film including many zinc phosphate crystals in the chemical conversion treatment step. Furthermore, it is found that the chemical conversion-treated film including many zinc phosphate crystals has excellent coating material adhesiveness.

The thickness of the oxide film layer 3 can be measured from a cross section using an electron probe micro-analyzer (EPMA), a transmission electron microscope (TEM), a glow discharge spectrometer (GDS), or the like. The interface between the oxide film layer 3 and the Al—Fe intermetallic compound layer 2 can be determined by observing the distribution of the concentration of oxygen. That is, the concentration of oxygen becomes higher in the oxide film layer 3 than in the Al—Fe intermetallic compound layer 2. In the present embodiment, a location at which the detection intensity of oxygen decreases to ⅙ of the maximum value is determined as the interface between the oxide film layer 3 and the Al—Fe intermetallic compound layer 2 using a GDS. Specifically, in a case where oxygen is measured in the thickness direction from the surface of the oxide film layer 3 at intervals of 0.1 seconds and a sputtering rate of 0.060 μm/second using a GDS, a measurement time in which the detection intensity of an oxygen atom becomes ⅙ of the maximum value is represented by T [seconds], and T is multiplied by the sputtering rate, thereby obtaining the thickness of the oxide film layer 3. Here, in a case where the detection intensity of an oxygen atom is detected to become ⅙ of the maximum value at a plurality of points, the longest time of the measurement times in which the detection intensity of an oxygen atom becomes ⅙ of the maximum value is represented by T [seconds], and T is multiplied by the sputtering rate, thereby obtaining the thickness of the oxide film layer 3.

In addition, the proportion of the A group element in the oxide film layer 3 can be measured using an energy-dispersive X-ray spectroscopy (EDX) function of a transmission electron microscope (TEM). Among the configurational elements of the oxide film layer, the amount ratios of the configurational elements excluding oxygen are obtained using the EDX function, and the total of the amount ratios of the A group elements among them are obtained, whereby the proportion of the A group element in the oxide film layer excluding oxygen can be obtained. For example, the proportion of impurities is small, and thus, when the total amount of the A group element, Al, Si, and Fe is set to 100 atom %, the proportion of the A group element is obtained in a unit of “atom %”, and the above-described proportion can be regarded as the proportion of the A group element in the oxide film layer 3.

As described above, the coating material adhesiveness can be improved by controlling the proportion (abundance) of the A group element in the oxide film layer 3. Generally, when a coating material is sufficiently adhered, corrosion is prevented; however, in a case where there is a defect in the coating material (electrodeposition coating film), there is a concern that pitting corrosion may occur at the location of the defect. Therefore, even a member that is used in a state in which it is coated with a coating material desirably has excellent pitting corrosion resistance.

In the hot stamped member according to the present embodiment, not only the coating material adhesiveness but also the pitting corrosion resistance are improved, and thus the present state (distribution state) of the A group element in the oxide film layer 3 is controlled.

Specifically, in the case of measuring the A group element in the oxide film layer 3 in the thickness direction from the surface of the oxide film layer 3 using a GDS, when the thickness of the oxide film layer 3 is represented by t, the maximum value of the detection intensity of the A group element in a range from the surface of the oxide film layer 3 to t/3 in the thickness direction is represented by a, and the average value of the detection intensities of the A group element in a range from 2t/3 to tin the thickness direction from the surface of the oxide film layer 3 is represented by b, a becomes 3.0 times or more b (a/b≥3.0). That is, the A group element is concentrated in the surface layer area of the oxide film layer 3. a/b is preferably equal to or larger than 8.0 and more preferably equal to or larger than 10.0. The upper limit of a/b is not particularly limited, but is practically approximately 50.0 when the hot stamping conditions and the like are taken into account.

In addition, the A group element is preferably concentrated in a portion closer to the surface layer, and when the maximum value of the detection intensity of the A group element in a range from the surface of the oxide film layer 3 to t/5 in the thickness direction is represented by a′ and the average value of the detection intensities of the A group element in a range from 2t/3 to tin the thickness direction from the surface of the oxide film layer 3 is represented by b, a′ is preferably 3.0 times or more b (a′/b≥3.0).

Here, in a case where a plurality of kinds of the A group elements are included in the oxide film layer 3, a/b (preferably also a′/b) needs to satisfy the above-described range for the A group element having the largest amount.

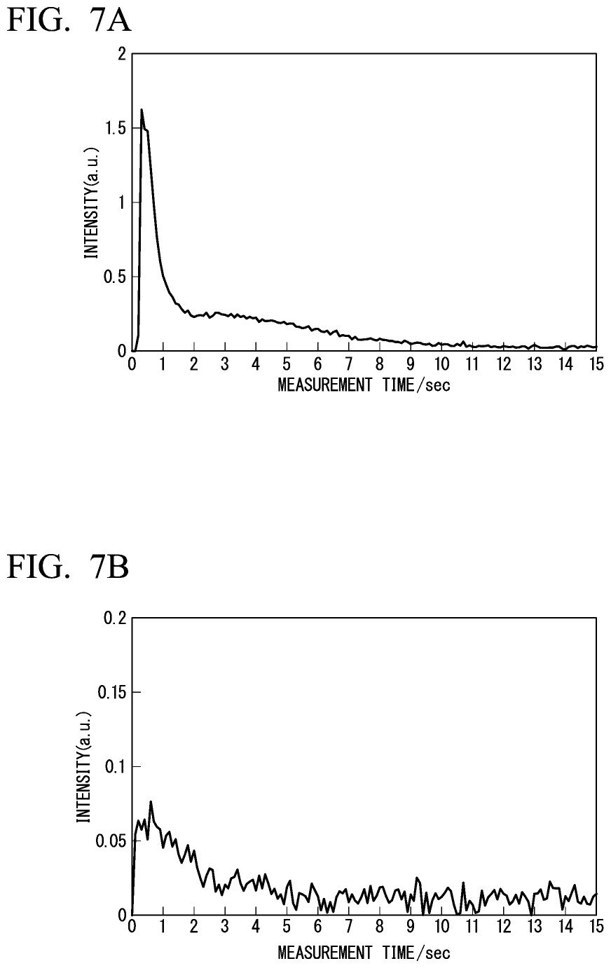

In the hot stamped member according to the present embodiment, the A group element is significantly concentrated in the surface layer of the oxide film layer 3 as shown in, for example, FIG. 7A. On the other hand, in a case where there is no particular control, the A group element is not sufficiently concentrated in the surface layer of the oxide film layer 3 as shown in FIG. 7B.

As described above, the thickness of the oxide film layer 3 is preferably 0.01 to 10.0 μm from the viewpoint of the coating material adhesiveness. However, the A group element is concentrated at the same time as the formation of the oxide film layer 3. When the oxide film layer 3 is thin, that is, the time taken for the formation of the oxide film layer 3 is short, the A group element is also insufficiently concentrated in the surface layer area. Therefore, in the case of concentrating the A group element in the surface layer area in the oxide film layer 3, the thickness of the oxide film layer 3 is preferably set to 0.10 μm or more. That is, in the case of improving the coating material adhesiveness and the pitting corrosion resistance, the thickness of the oxide film layer 3 is preferably set to 0.10 to 10.0 μm.

(Steel 1)

Next, the steel 1 that the hot stamped member according to the present embodiment includes is not particularly limited as long as the steel can be preferably used in the hot stamping method. As a steel applicable to the hot stamped member according to the present embodiment, for example, a steel containing, as the chemical composition, by mass %, C: 0.1% to 0.4%, Si: 0.01% to 0.60%, Mn: 0.50% to 3.00%, P: 0.05% or less, S: 0.020% or less, Al: 0.10% or less, Ti: 0.01% to 0.10%, B: 0.0001% to 0.0100%, and N: 0.010% or less with a remainder of Fe and impurities can be exemplified. As the form of the steel 1, for example, a steel sheet such as a hot-rolled steel sheet or a cold-rolled steel sheet can be exemplified. Hereinafter, the components of the steel will be described.

C: 0.1% to 0.4%

C is contained in order to ensure an intended mechanical strength. In a case where the amount of C is less than 0.1%, the mechanical strength cannot be sufficiently improved, and the effect of the containing of C becomes poor. On the other hand, in a case where the amount of C exceeds 0.4%, the strength of the steel sheet can be further hardened and improved, but elongation and reduction in area are likely to degrade. Therefore, the amount of C is desirably in a range of 0.1% or more and 0.4% or less by mass %.

Si: 0.01% to 0.60%

Si is one of strength improvement elements that improve the mechanical strength and, similar to C, is contained in order to ensure an intended mechanical strength. In a case where the amount of Si is less than 0.01%, a strength improvement effect is not easily exhibited, and the mechanical strength cannot be sufficiently improved. On the other hand, Si is an easily-oxidizing element, and thus, in a case where the amount of Si exceeds 0.60%, due to the influence of a Si oxide formed on the surface layer of the steel sheet, during molten Al plating, the wettability degrades, and there is a concern that non-plating may occur. Therefore, the amount of Si is desirably in a range of 0.01% or more and 0.60% or less by mass %.

Mn: 0.50% to 3.00%

Mn is one of strengthening elements that strengthen steel and also one of elements that enhance hardenability. Furthermore, Mn is effective for preventing hot embrittlement caused by S which is one of the impurities. In a case where the amount of Mn is less than 0.50%, these effects cannot be obtained, and the above-described effects are exhibited at an amount of Mn being 0.50% or more. Meanwhile, Mn is an austenite-forming element, and thus, in a case where the amount of Mn exceeds 3.00%, residual austenite excessively increases, and there is a concern that the strength may decrease. Therefore, the amount of Mn is desirably in a range of 0.50% or more and 3.00% or less by mass %.

P: 0.05% or less

P is an impurity that is included in steel. There are cases where P included in a steel is segregated at grain boundaries in the steel, degrades the toughness of a base metal of a hot stamped formed body, and degrades the delayed fracture resistance of the steel. Therefore, the amount of P in the steel is preferably 0.05% or less, and the amount of P is preferably as small as possible.

S: 0.020% or less

S is an impurity that is included in steel. There are cases where S in a steel forms a sulfide, degrades the toughness of the steel, and degrades the delayed fracture resistance of the steel. Therefore, the amount of S in the steel is preferably 0.020% or less, and the amount of S in the steel is preferably set to be as small as possible.

Al: 0.10% or less

Al is generally used for the purpose of deoxidizing steel. However, in a case where the amount of Al is large, the Ac3 point of the steel increases, and thus it is necessary to increase a heating temperature necessary to ensure the hardenability of steel during hot stamping, which is not desirable in terms of manufacturing by hot stamping. Therefore, the amount of Al in the steel is preferably 0.10% or less, more preferably 0.05% or less, and still more preferably 0.01% or less.

Ti: 0.01% to 0.10%

Ti is one of strengthening elements. In a case where the amount of Ti is less than 0.01%, a strength improvement effect or an oxidation resistance improvement effect cannot be obtained, and these effects are exhibited when the amount of Ti is 0.01% or more. On the other hand, when Ti is excessively contained, there is a concern that, for example, a carbide or a nitride may be formed and the steel may be softened. Particularly, in a case where the amount of Ti exceeds 0.10%, there is a possibility that an intended mechanical strength cannot be obtained. Therefore, the amount of Ti is desirably in a range of 0.01% or more and 0.10% or less by mass %.

B: 0.0001% to 0.0100%

B has an effect of improving the strength by acting during quenching. In a case where the amount of B is less than 0.0001%, such a strength improvement effect is weak. On the other hand, in a case where the amount of B exceeds 0.0100%, there is a concern that an inclusion may be formed, the steel may become brittle, and the fatigue strength may decrease. Therefore, the amount of B is desirably in a range of 0.0001% or more and 0.0100% or less by mass %.

N: 0.010% or less

N is an impurity that is included in steel. There are cases where N included in a steel forms a nitride and degrades the toughness of the steel. Furthermore, in a case where B is contained in the steel, there are cases where N included in the steel bonds to B to decrease the amount of a solid solution of B and weaken the hardenability improvement effect of B. Therefore, the amount of N in the steel is preferably 0.010% or less, and the amount of N in the steel is more preferably set to be as small as possible.

In addition, the steel configuring the hot stamped member according to the present embodiment may also include elements that improve hardenability such as Cr and Mo.

Cr: 0% to 1.0%

Mo: 0% to 1.0%

In order to improve the hardenability of the steel, any one or both of Cr and Mo may be contained. In the case of obtaining a result thereof, the amount of either is preferably set to 0.01% or more. On the other hand, even when the amount is set to 1.0% or more, the effect is saturated, and thus the cost increases. Therefore, the amount is preferably set to 1.0% or less.

The remainder other than the above-described components is iron and impurities. The steel may also include impurities that are mixed into the steel during other manufacturing steps and the like. As the impurities, for example, boron (B), carbon (C), nitrogen (N), sulfur (S), zinc (Zn), and cobalt (Co) are exemplified.

The steel having the above-described chemical composition can be produced into a hot stamped member having a tensile strength of approximately 1,000 MPa by heating and quenching the steel using the hot stamping method. In addition, in the hot stamping method, the steel can be pressed in a state in which it is softened at a high temperature, and thus it is possible to easily form the steel.

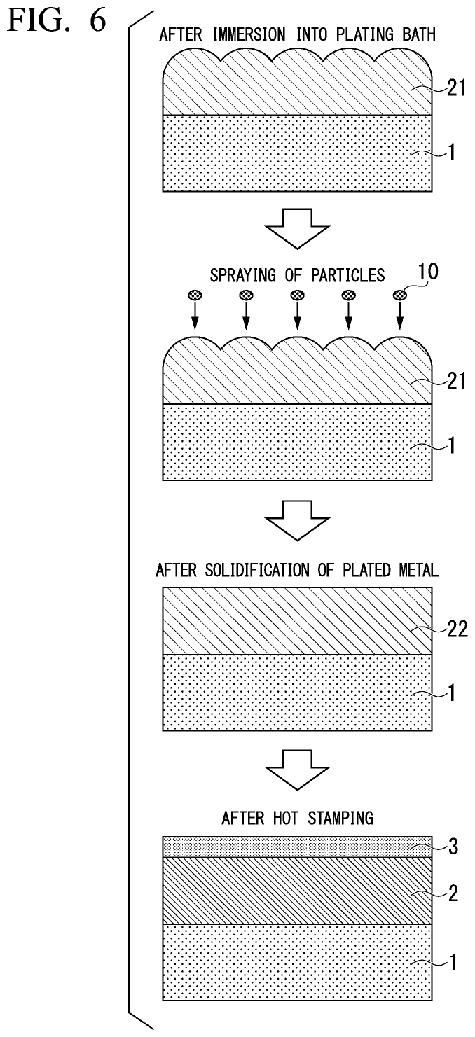

(Method for manufacturing hot stamped member) Next, an example of a method for manufacturing the hot stamped member according to the present embodiment will be described with reference to FIG. 6. The manufacturing method described below is an example in which Al plating is carried out on a steel to produce an aluminum-plated steel, and a hot stamping step is carried out on the aluminum-plated steel, thereby forming the Al—Fe intermetallic compound layer 2 and the oxide film layer 3 on the surface of the steel 1. However, the method to be described below is simply an example, and the manufacturing method is not limited to the present method.

<Al Plating Step>

(Immersion into Plating Bath)

An Al plating layer is formed on the surface of a steel sheet using, for example, a hot-dip plating method. The Al plating layer of the aluminum-plated steel is formed on a single surface or both surfaces of a steel.

During hot-dip plating, a heating step for hot stamping, or the like, at least some of Al included in the Al plating layer is capable of forming an alloy with Fe in the steel. Therefore, the Al plating layer is not always formed as a single layer having uniform components and may include an appropriately alloyed layer.

Al and the A group element are added to a hot-dip plating bath in the hot-dip plating method. In addition, Si may be added to the hot-dip plating bath. The amount of the A group element added to the hot-dip plating bath is set to 0.001 mass % or more and 30 mass % or less, and the amount of Si added thereto is set to 20 mass % or less. The steel is immersed in the hot-dip plating bath to which Al, the A group element, and, as necessary, Si are added, thereby forming an Al plating layer on the surface of the steel. The A group element is included in the formed Al plating layer. In addition, there are cases where Si and Fe are included in the Al plating layer.

(Spraying of Particles)

Next, particles 10 of a nitride, a carbide, an oxide, or the like are sprayed to the steel 1 immediately after it is lifted from the hot-dip plating bath together with a cooling gas such as air, nitrogen, or argon before the solidification of a molten metal (a plated metal 21 in a molten state) adhered to the steel by the immersion into the hot-dip plating bath. The sprayed particles 10 serve as nuclei of crystals and have an effect of decreasing the grain sizes in the Al plating layer in a solidified plated metal 22. This effect is particularly strong on the surface side on which the particles are sprayed. A decrease in the grain sizes in the Al plating layer increases grain boundaries and increases the interfacial area with an atmosphere gas such as the atmosphere during hot stamping heating that is subsequently carried out. The A group element has a high affinity to the atmosphere gas, and thus the amount of the A group element concentrated in the surface layer increases, and the proportion of the A group element in the surface layer area of the oxide film layer 3 increases.

The size of the particles 10 of the sprayed nitride, carbide, oxide, or the like is not particularly limited. However, when the particle diameter exceeds 20 μm, the crystal grains in the Al plating layer increase, and it becomes difficult for the A group element to be concentrated in the surface layer. Therefore, the particles 10 desirably have a particle diameter of 20 μm or less. As the sprayed nitride, carbide, and oxide, titanium nitride, silicon nitride, titanium carbide, silicon carbide, titanium oxide, silicon oxide, iron oxide, aluminum oxide, and the like are exemplified. The adhesion amount of the particles 10 is preferably set to, for example, 0.01 to 1.0 g/m². When the adhesion amount of the particles 10 is in this range, a sufficient amount of crystal nuclei are formed in the Al plating layer, particularly, the surface layer area. Therefore, the grain sizes in the Al plating layer sufficiently decrease, and it is possible to concentrate the A group element in the surface layer area of the oxide film layer 3 by heating during hot stamping.

<Hot Stamping Step>

Hot stamping is carried out on the aluminum-plated steel manufactured as described above. In the hot stamping method, the aluminum-plated steel is blanked (punched) as necessary, and then the aluminum-plate steel is softened by heating. In addition, the softened aluminum-plated steel is formed by pressing and then cooled. The steel 1 is quenched by heating and cooling, thereby obtaining a high tensile strength of approximately 1,000 MPa or more. As a heating method, it is possible to employ the method, using an ordinary electric furnace or an ordinary radiant tube furnace, using infrared heating or the like.

The heating temperature and the heating time during hot stamping are, in the case of an air atmosphere, preferably set to 850° C. to 950° C. for two minutes or longer. When the heating time is shorter than two minutes, the concentration of the A group element in the oxide film layer 3 does not proceed, and thus the coating material adhesiveness or pitting corrosion resistance improvement effect of the hot stamped member becomes insufficient.

In addition, in the case of hot-stamping the aluminum-plated steel in an atmosphere having a concentration of oxygen being 5% or less, the heating time is preferably set to 3 minutes or longer. When the heating time is shorter than three minutes, the thickness of the oxide film layer 3 does not become sufficiently large, and thus the proportion of the A group element in the oxide film layer 3 or the concentration of the A group element in the surface layer area of the oxide film layer 3 becomes insufficient.

Hot stamping changes the Al plating layer to the Al—Fe intermetallic compound layer 2 and forms the oxide film layer 3 on the surface of the Al—Fe intermetallic compound layer 2. Heating during hot stamping melts the Al plating layer and causes Fe to diffuse from the steel 1, whereby the Al—Fe intermetallic compound layer 2 including an Al—Fe alloy phase or an Al—Fe—Si alloy phase is formed. The Al—Fe intermetallic compound layer 2 is not always formed as a single layer having a uniform component composition and may be a layer including a partially alloyed layer.

In addition, the A group element included in the Al plating layer is concentrated in the surface layer of the Al plating layer, and oxygen in the atmosphere oxidizes the surface of the Al plating layer, whereby the oxide film layer 3 including the A group element is formed. By spraying of the particles 10, a sufficient amount of crystal nuclei are formed in the Al plating layer, particularly, the surface layer area thereof Therefore, the grain sizes in the Al plating layer sufficiently decrease, and it is possible to concentrate the A group element in the surface layer area of the oxide film layer 3 by hot stamping heating. All of the A group element added to the Al plating layer may transfer to the oxide film layer 3 or some of the A group element may transfer to the oxide film layer 3 while the remainder remains in the Al—Fe intermetallic compound layer 2.

In addition, the hot stamped member according to the present embodiment may also be manufactured by forming an Al-coated layer including the A group element by attaching Al and the A group element to the surface of the steel 1 by deposition or thermal spraying instead of hot-dip plating, and additionally hot-stamping the steel 1 having this Al-coated layer.

In addition, as an example of a method for forming the Al-coated layer, Al may be attached to the steel first by deposition and thermal spraying, and then the A group element may be attached thereto. In such a case, the Al plating layer made up of an Al layer and the A group element is formed.

In addition, as another example of the method for forming the Al-coated layer, Al and the A group element may be attached to the steel at the same time by carrying out deposition or thermal spraying using a deposition source or a thermal spraying source including the A group element. The proportion of the A group element in the Al plating layer is preferably 0.001% to 30 mass %.

After that, similar to the case of the aluminum-plated steel, hot stamping is carried out on the steel 1 having the Al-coated layer, whereby the hot stamped member according to the present embodiment can be manufactured.

### EXAMPLES

Examples of the present invention will be described, but conditions in the examples are examples of the conditions employed to confirm the feasibility and effect of the present invention, and the present invention is not limited to the examples of the conditions. The present invention is capable of employing a variety of conditions within the scope of the gist of the present invention as long as the object of the present invention is achieved.

As a steel sheet before plating, a steel sheet having a high mechanical strength (which includes a variety of properties relating to mechanical distortion and fracture such as a tensile strength, a yield point, an elongation, a reduction in area, a hardness, an impact value, and a fatigue strength) is desirably used. Examples of the steel sheet before plating which is used for the steel sheet for hot stamping of the present invention are shown in Table 1.

TABLE 1

| Steel | Chemical composition (mass %), remainder is iron and impurities | | | | | | | | | | |
|---|---|---|---|---|---|---|---|---|---|---|---|
| No. | C | Si | Mn | P | S | Al | Ti | B | N | Cr | Mo |
| S1 | 0.1 | 0.21 | 1.21 | 0.02 | 0.005 | 0.05 | 0.02 | 0.0030 | 0.005 | — | — |
| S2 | 0.4 | 0.01 | 1.01 | 0.04 | 0.010 | 0.03 | 0.04 | 0.0022 | 0.004 | — | — |
| S3 | 0.2 | 0.60 | 0.90 | 0.03 | 0.010 | 0.04 | 0.03 | 0.0022 | 0.003 | — | — |
| S4 | 0.3 | 0.01 | 0.50 | 0.04 | 0.010 | 0.04 | 0.04 | 0.0022 | 0.008 | — | — |
| S5 | 0.2 | 0.60 | 3.00 | 0.03 | 0.004 | 0.01 | 0.03 | 0.0030 | 0.003 | — | — |
| S6 | 0.2 | 0.21 | 1.01 | 0.05 | 0.004 | 0.01 | 0.02 | 0.0030 | 0.004 | — | — |
| S7 | 0.2 | 0.01 | 0.90 | 0.01 | 0.020 | 0.03 | 0.02 | 0.0030 | 0.009 | — | — |
| S8 | 0.2 | 0.60 | 1.01 | 0.01 | 0.004 | 0.10 | 0.02 | 0.0025 | 0.004 | — | — |
| S9 | 0.2 | 0.21 | 1.05 | 0.03 | 0.004 | 0.03 | 0.01 | 0.0029 | 0.005 | — | — |
| S10 | 0.2 | 0.23 | 0.90 | 0.04 | 0.004 | 0.03 | 0.10 | 0.0087 | 0.005 | — | — |
| S11 | 0.2 | 0.25 | 0.95 | 0.03 | 0.004 | 0.01 | 0.04 | 0.0001 | 0.003 | — | — |
| S12 | 0.3 | 0.21 | 2.01 | 0.04 | 0.004 | 0.01 | 0.03 | 0.0100 | 0.004 | — | — |
| S13 | 0.3 | 0.03 | 0.90 | 0.02 | 0.010 | 0.01 | 0.02 | 0.0048 | 0.010 | — | — |
| S14 | 0.3 | 0.01 | 0.95 | 0.02 | 0.010 | 0.03 | 0.02 | 0.0048 | 0.005 | — | — |
| S15 | 0.2 | 0.21 | 0.90 | 0.04 | 0.010 | 0.03 | 0.02 | 0.0029 | 0.008 | — | — |
| S16 | 0.3 | 0.12 | 0.50 | 0.04 | 0.008 | 0.04 | 0.04 | 0.0022 | 0.008 | 0.22 | — |
| S17 | 0.3 | 0.13 | 0.51 | 0.04 | 0.008 | 0.04 | 0.04 | 0.0022 | 0.008 | — | 0.21 |
| S18 | 0.3 | 0.14 | 0.53 | 0.04 | 0.009 | 0.04 | 0.04 | 0.0022 | 0.008 | 0.24 | 0.24 |

For each of the steel sheets having the chemical compositions shown in Table 1 (Steels Nos. S1 to S18), Al plating layers were formed on both surfaces of the steel sheet using a hot-dip plating method. During hot-dip plating, the plating bath temperature was set to 700° C., and after the steel sheet was immersed in the plating bath, the adhesion amount was adjusted to 70 g/m² per surface using a gas wiping method. After that, in examples except for reference symbols a4 and a5, titanium oxide having a particle diameter of 0.05 μm was sprayed before the solidification of the plating layer so that the average adhesion amount reached 0.1 g/m². In the reference symbols a4 and a5, no particles were sprayed.

0.001% or more and 30.0% or less, by mass %, of an A group element was added to the plating bath. As the A group element, one or more selected from Sc, Ti, V, Cr, Mn, Fe, Co, Ni, Cu, Zn, Mg, Ca, Ba, Sr, and Ti was selected. After that, the Al-plated steel sheet was heated in an electric resistance furnace, in which a furnace temperature is 900° C. so that the soaking time reached five minutes. After that, the Al-plated steel sheet was formed in a mold, and at the same time, cooled in the mold, thereby obtaining a hot stamped member.

For the obtained hot stamped member, the proportion of the A group element in an oxide film layer of the hot stamped member, the degree of concentration of the A group element in the surface layer of the oxide film layer of the hot stamped member, a compound included in the oxide film layer, and the thickness of the oxide film layer were investigated. In addition, as characteristics, coating material adhesiveness, corrosion resistance after coating, and pitting corrosion resistance were investigated. The results are shown in Table 2A and Table 2B.

While not shown in the tables, for all of the examples, the thicknesses of the Al—Fe intermetallic compound layers were in a range of 0.1 to 10.0 μm.

(1) Oxide Film Layer

The kind of a compound in the oxide film layer was determined by measuring the electron beam diffraction using a transmission electron microscope (TEM). In addition, the proportion of the A element was measured using an energy-dispersive X-ray spectroscopy (EDX) function of the transmission electron microscope (TEM). Among configurational elements of the oxide film layer, the amount ratios of the configurational elements excluding oxygen were obtained using the EDX function, and the total of the amount ratios of the A group elements among them were obtained, whereby the proportion of the A group element in the oxide film layer excluding oxygen was obtained. Specifically, the proportion of the A group element when the total amount of the A group element, Al, Si, and Fe was set to 100 atom % was obtained in units of “atom %”.

The oxide film layers of the examples and comparative examples obtained this time included an oxide of the A group element, included aluminum oxide as a remainder, and further included impurities. Furthermore, some of testing examples, the oxide film layers included silicon oxide.

The thickness of the oxide film layer was obtained by determining a location at which the detection intensity of oxygen decreased to ⅙ of the maximum value as the interface between the oxide film layer and an Al—Fe intermetallic compound layer using a GDS. More specifically, in a case where oxygen was measured in the thickness direction from the surface of the oxide film layer at intervals of 0.1 seconds and a sputtering rate of 0.060 μm/second using a GDS, among measurement times in which the detection intensity of an oxygen atom became ⅙ of the maximum value, the longest time was represented by T [seconds], and T was multiplied by the sputtering rate, thereby obtaining the thickness of the oxide film layer.

In addition, for the A group element having the largest amount, the proportion between the maximum value of the detection intensity of the A group element in a range from the surface layer to a location at one-third of the thickness of the oxide film thickness in the thickness direction from the surface layer (the maximum value of the detection intensity of the A group element at a measurement time of 0 to T/3 (seconds)) and the average value of the detection intensities of the A group element in a range from a location at two thirds of the thickness of the oxide film thickness in the thickness direction from the surface layer to the interface between the oxide film layer and the Al—Fe intermetallic compound layer (the average value of the detection intensities of the A group element at a measurement time of T/3 (seconds) to T (seconds)) was obtained (detection intensity proportion 1 in the tables).

Similarly, the proportion between the maximum value of the detection intensity of the A group element in a range from the surface layer to a location at a fifth of the thickness of the oxide film thickness in the thickness direction from the surface layer and the average value of the detection intensities of the A group element in a range from a location at two thirds of the thickness of the oxide film thickness in the thickness direction from the surface layer to the interface between the oxide film layer and the Al—Fe intermetallic compound layer was obtained (detection intensity proportion 2 in the tables).

(2) Coating material adhesiveness

The coating material adhesiveness was evaluated according to a method described in Japanese Patent No. 4373778. That is, the coating material adhesiveness was graded on the basis of an area ratio calculated by immersing a sample in deionized water (60° C.) for 240 hours, inscribing 100 grids at intervals of 1 mm using a cutter knife, and visually measuring the number of exfoliated portions of the grid cells.

(Grades)

3: The exfoliated area is 0% or more and less than 10%.

2: The exfoliated area is 10% or more and less than 70%.

1: The exfoliated area is 70% or more and 100% or less.

(3) Corrosion resistance after coating

The corrosion resistance after coating was evaluated using a method regulated in JASO M609 established by Society of Automotive Engineers of Japan, Inc. A mark was inscribed in a coating film using a cutter knife, and the width (the maximum value on a single side) of the blister of coating film from the cut mark after 180 cycles of a corrosion test was measured.

(Grades)

3: The blister width is 0 mm or more and less than 1.5 mm.

2: The blister width is 1.5 mm or more and less than 3 mm.

1: The blister width is 3 mm or more.

(4) Pitting corrosion resistance

The pitting corrosion resistance was evaluated using the following method.

A sample was immersed in PREPALENE-X which is a surface conditioner manufactured by Nihon Parkerizing Co., Ltd., at a normal temperature for one minute and then immersed in PALBOND SX35 which is a chemical conversion agent for a coating base material manufactured by the same company, at 35° C. for two minutes. After that, the sample was subjected to a complex cycle corrosion test using a method described in JIS H 8502. A coating film having a thickness of 15 μm was coated thereto using POWER FLOAT 1200 manufactured by Nipponpaint Industrial Coatings Co., Ltd., and a cut was imparted using a cutter knife as described in JIS H 8502. A grade was given as described below on the basis of the reduced amount of the sheet thickness of the steel sheet in a portion imparted with the cut after 60 cycles.

[Grades]

5: The amount of the sheet thickness reduced is less than 0.1 mm.

4: The amount of the sheet thickness reduced is 0.1 mm or more and less than 0.2 mm.

3: The amount of the sheet thickness reduced is 0.2 mm or more and less than 0.3 mm.

2: The amount of the sheet thickness reduced is 0.3 mm or more and less than 0.4 mm.

1: The amount of the sheet thickness reduced is 0.4 mm or more.

TABLE 2A

| | | | Oxide film layer | | | | | | | | | | | Characteristics | | |
|---|---|---|---|---|---|---|---|---|---|---|---|---|---|---|---|---|
| | | | | Proportion | | Detection | Detection | Compound configuring oxide film layer ※ Remainder is impurities | | | | | | | Corrosion | |
| | | | A | of A group | | intensity | intensity | Compound (p) | | Compound (q) | | Compound (r) | | Coating | resistance | Pitting |
| | | | group | element | Thickness | proportion 1 | proportion 2 | Kind of | Proportion | Kind of | Proportion | Kind of | Proportion | material | after | corrosion |
| | Symbol | Steel No. | element | (atom %) | [um] | — | — | compound | (mass %) | compound | (mass %) | compound | (mass %) | adhesiveness | coating | resistance |
| Invention | A1 | S1 | Sc | 24 | 0.10 | 3.4 | 3.1 | Sc₂O₃ | 27 | Al₂O₃ | 45 | SiO₂ | 27 | 3 | 3 | 3 |
| Example | A2 | S1 | Ti | 55 | 0.13 | 3.2 | 3.1 | TiO₂ | 58 | Al₂O₃ | 35 | SiO₂ | 6 | 3 | 3 | 3 |
| | A3 | S1 | V | 76 | 0.15 | 3.6 | 3.3 | V₂O₃ | 79 | Al₂O₃ | 16 | SiO₂ | 4 | 3 | 3 | 3 |
| | A4 | S2 | Cr | 79 | 0.10 | 5.1 | 4.8 | Cr₂O₃ | 82 | Al₂O₃ | 10 | SiO₂ | 7 | 3 | 3 | 3 |
| | A5 | S3 | Mn | 15 | 0.40 | 4.6 | 4.3 | MnO | 18 | Al₂O₃ | 43 | SiO₂ | 38 | 3 | 3 | 3 |
| | A6 | S4 | Fe | 30 | 0.15 | 4.6 | 4.3 | Fe₂O₃ | 33 | Al₂O₃ | 41 | SiO₂ | 25 | 3 | 3 | 3 |
| | A7 | S5 | Co | 10 | 0.10 | 4.6 | 4.3 | CoO | 13 | Al₂O₃ | 50 | SiO₂ | 36 | 3 | 3 | 3 |
| | A8 | S6 | Ni | 5 | 0.12 | 5.1 | 4.8 | NiO | 8 | Al₂O₃ | 66 | SiO₂ | 25 | 3 | 3 | 3 |
| | A9 | S7 | Cu | 22 | 1.0 | 5.3 | 5.1 | CuO | 25 | Al₂O₃ | 54 | SiO₂ | 20 | 3 | 3 | 3 |
| | A10 | S8 | Zn | 29 | 0.10 | 5.1 | 4.8 | ZnO | 32 | Al₂O₃ | 59 | SiO₂ | 8 | 3 | 3 | 3 |
| | A11 | S9 | Mg | 32 | 8.0 | 7.1 | 6.8 | MgO | 35 | Al₂O₃ | 60 | SiO₂ | 4 | 3 | 3 | 3 |
| | A12 | S10 | Ca | 6 | 0.10 | 3.2 | 2.9 | CaO | 9 | Al₂O₃ | 76 | SiO₂ | 14 | 3 | 3 | 3 |
| | A13 | S1 | Ba | 4 | 0.10 | 4.5 | 4.2 | BaO | 7 | Al₂O₃ | 78 | SiO₂ | 14 | 3 | 3 | 3 |
| | A14 | S11 | Sr | 20 | 10.0 | 5.2 | 4.9 | SrO | 23 | Al₂O₃ | 59 | SiO₂ | 17 | 3 | 3 | 3 |
| | A15 | S12 | Ti | 0.01 | 0.13 | 6.1 | 5.8 | TiO₂ | 0.01 | Al₂O₃ | 81 | SiO₂ | 18 | 3 | 2 | 3 |
| | A16 | S13 | Ti | 0.04 | 0.10 | 8.0 | 7.8 | TiO₂ | 0.07 | Al₂O₃ | 52 | SiO₂ | 47 | 3 | 2 | 4 |
| | A17 | S14 | Ti | 14 | 1.0 | 10.0 | 9.7 | TiO₂ | 17 | Al₂O₃ | 71 | SiO₂ | 11 | 3 | 3 | 5 |
| | A18 | S15 | Ti | 80 | 10.0 | 11.4 | 11.1 | TiO₂ | 83 | Al₂O₃ | 13 | SiO₂ | 3 | 3 | 2 | 5 |
| | A19 | S16 | Mg | 32 | 8.0 | 8.0 | 7.7 | MgO | 35 | Al₂O₃ | 51 | SiO₂ | 13 | 3 | 3 | 4 |
| | A20 | S17 | Mg | 32 | 8.0 | 25.0 | 24.7 | MgO | 35 | Al₂O₃ | 45 | SiO₂ | 19 | 3 | 3 | 5 |
| | A21 | S18 | Mg | 32 | 8.0 | 50.0 | 49.7 | MgO | 35 | Al₂O₃ | 47 | SiO₂ | 17 | 3 | 3 | 5 |
| | A22 | S1 | Cr | 0.01 | 0.40 | 19.5 | 19.3 | Cr₂O₃ | 0.01 | Al₂O₃ | 76 | SiO₂ | 23 | 3 | 2 | 5 |
| | A23 | S5 | Cr | 1 | 0.12 | 12.3 | 12.0 | Cr₂O₃ | 4 | Al₂O₃ | 81 | SiO₂ | 14 | 3 | 2 | 5 |
| | A24 | S6 | Cr | 50 | 5.0 | 8.6 | 8.3 | Cr₂O₃ | 53 | Al₂O₃ | 46 | — | — | 3 | 3 | 4 |
| | A25 | S7 | Cr | 80 | 7.0 | 15.8 | 15.5 | Cr₂O3 | 80 | Al₂O₃ | 16 | SiO₂ | 3 | 3 | 2 | 5 |
| | A26 | S7 | Sr | 0.01 | 3.0 | 6.8 | 6.6 | SrO | 0.01 | Al₂O₃ | 81 | SiO₂ | 18 | 3 | 2 | 3 |
| | A27 | S8 | Sr | 0.09 | 0.80 | 20.5 | 20.2 | SrO | 0.09 | Al₂O₃ | 83 | SiO₂ | 16 | 3 | 2 | 5 |
| | A28 | S9 | Sr | 22 | 0.72 | 32.2 | 32.0 | SrO | 24 | Al₂O₃ | 74 | SiO₂ | 1 | 3 | 3 | 5 |
| | A29 | S10 | Sr | 80 | 0.54 | 30.6 | 30.4 | SrO | 80 | Al₂O₃ | 17 | SiO₂ | 2 | 3 | 2 | 5 |
| | A30 | S8 | Ca | 0.01 | 0.24 | 3.0 | 2.7 | CaO | 0.01 | Al₂O₃ | 88 | SiO₂ | 11 | 3 | 2 | 6 |

TABLE 2B

| | | | Oxide film layer | | | | | | | | | | | Characteristics | | |
|---|---|---|---|---|---|---|---|---|---|---|---|---|---|---|---|---|
| | | | | Proportion | | Detection | Detection | Compound configuring oxide film layer ※ Remainder is impurities | | | | | | | Corrosion | |
| | | | A | of A group | | intensity | intensity | Compound (p) | | Compound (q) | | Compound (r) | | Coating | resistance | Pitting |
| | | Steel | group | element | Thickness | proportion 1 | proportion 2 | Kind of | Proportion | Kind of | Proportion | Kind of | Proportion | material | after | corrosion |
| | Symbol | No. | element | (atom %) | [um] | — | — | compound | (mass %) | compound | (mass %) | compound | (mass %) | adhesiveness | coating | resistance |
| Invention | A31 | S9 | Ca | 1 | 0.10 | 8.0 | 7.8 | CaO | 4 | Al₂O₃ | 89 | SiO₂ | 6 | 3 | 2 | 4 |
| Example | A32 | S10 | Ca | 50 | 0.10 | 3.6 | 3.6 | CaO | 53 | Al₂O₃ | 41 | SiO₂ | 5 | 3 | 3 | 3 |
| | A33 | S8 | Ca | 80 | 0.12 | 4.3 | 4.1 | CaO | 80 | Al₂O₃ | 18 | SiO₂ | 1 | 3 | 2 | 3 |
| | A34 | S9 | Co | 0.01 | 0.12 | 3.1 | 3.1 | CaO | 0.01 | Al₂O₃ | 84 | SiO₂ | 15 | 3 | 2 | 3 |
| | A35 | S4 | Co | 17 | 0.10 | 5.9 | 5.6 | CaO | 20 | Al₂O₃ | 76 | SiO₂ | 3 | 3 | 2 | 3 |
| | A36 | S5 | Co | 56 | 1.0 | 6.8 | 6.5 | CaO | 57 | Al₂O₃ | 41 | SiO₂ | 1 | 3 | 2 | 3 |
| | A37 | S9 | Co | 80 | 10.0 | 8.0 | 8.0 | CaO | 83 | Al₂O₃ | 14 | SiO₂ | 2 | 3 | 2 | 4 |
| | A38 | S7 | Mg | 0.01 | 3.0 | 3.4 | 3.4 | MgO | 0.01 | Al₂O₃ | 91 | SiO₂ | 8 | 3 | 2 | 3 |
| | A39 | S8 | Mg | 0.5 | 0.10 | 3.8 | 3.6 | MgO | 3.5 | Al₂O₃ | 80 | SiO₂ | 16 | 3 | 2 | 3 |
| | A40 | S9 | Mg | 8 | 0.72 | 4.7 | 4.4 | MgAl₂O₄ | 11 | Al₂O₃ | 88 | — | — | 3 | 3 | 4 |
| | A41 | S10 | Mg | 45 | 0.87 | 3.3 | 3.1 | MgAl₂O₄ | 48 | Al₂O₃ | 41 | SiO₂ | 10 | 3 | 2 | 4 |
| | A42 | S10 | Mg | 80 | 2.0 | 3.9 | 3.9 | MgO | 80 | Al₂O₃ | 14 | SiO₂ | 5 | 3 | 2 | 3 |
| | A43 | S8 | Mn | 0.01 | 0.11 | 5.4 | 5.4 | MnO | 0.01 | Al₂O₃ | 94 | SiO₂ | 5 | 3 | 2 | 3 |
| | A44 | S9 | Mn | 3 | 0.12 | 3.8 | 3.8 | MnO | 5 | Al₂O₃ | 92 | SiO₂ | 2 | 3 | 2 | 3 |
| | A45 | S10 | Mn | 47 | 0.10 | 6.5 | 6.5 | MnO | 49 | Al₂O₃ | 41 | SiO₂ | 9 | 3 | 3 | 3 |
| | A46 | S8 | Mn | 80 | 0.14 | 6.4 | 6.2 | MnO | 82 | Al₂O₃ | 11 | SiO₂ | 6 | 3 | 2 | 3 |
| | A47 | S9 | Ti | 15 | 0.10 | 7.9 | 7.6 | TiO₂ | 17 | Al₂O₃ | 60 | SiO₂ | 22 | 3 | 2 | 3 |
| | A48 | S4 | Ti | 17 | 1.0 | 3.9 | 3.6 | TiO₂ | 19 | Al₂O₃ | 46 | SiO₂ | 34 | 3 | 2 | 3 |
| | A49 | S5 | Ti | 56 | 10.0 | 3.1 | 3.1 | TiO₂ | 58 | Al₂O₃ | 35 | SiO₂ | 6 | 3 | 2 | 3 |
| | A50 | S8 | Sr, Ca | 29 | 0.72 | 3.5 | 3.3 | SrO | 31 | CaO | 53 | Al₂O₃ | 15 | 3 | 2 | 3 |
| | A51 | S9 | Sr, Mg | 49 | 0.87 | 3.1 | 2.9 | SrO | 18 | MgO | 44 | Al₂O₃ | 37 | 3 | 2 | 3 |
| | A52 | S8 | Ca, Mg | 26 | 0.10 | 4.8 | 4.6 | CaO | 5 | MgO | 43 | Al₂O₃ | 51 | 3 | 2 | 3 |
| | A53 | S9 | Ca, Mg | 26 | 0.72 | 8.5 | 8.5 | CaO | 8 | MgO | 54 | Al₂O₃ | 37 | 3 | 2 | 4 |
| | A54 | S8 | Ti, Mg | 70 | 0.87 | 5.9 | 5.6 | TiO₂ | 44 | MgO | 21 | Al₂O₃ | 34 | 3 | 2 | 3 |
| | A55 | S9 | Sr, Ca | 29 | 0.72 | 7.4 | 7.2 | SrO | 20 | CaO | 4 | Al₂O₃ | 75 | 3 | 2 | 3 |
| | A56 | S8 | Mn, Mg | 14 | 0.87 | 3.5 | 3.2 | MnO | 10 | MgO | 2 | Al₂O₃ | 87 | 3 | 2 | 3 |
| | A57 | S9 | Mn, Mg | 26 | 1.0 | 8.4 | 8.2 | MnO | 8 | MgO | 15 | Al₂O₃ | 76 | 3 | 2 | 4 |
| Comparative | a1 | S1 | — | — | 0.10 | — | — | Al₂O₃ | 100 | — | — | — | — | 2 | 1 | 2 |
| Example | a2 | S1 | Ti | 0.005 | 0.040 | 0.4 | 2.9 | TiO₂ | 0.005 | Al₂O₃ | 35 | SiO₂ | 63 | 2 | 1 | 2 |
| | a3 | S1 | Ti | 95 | 0.090 | 0.9 | 3.1 | TiO₂ | 95 | Al₂O₃ | 2 | SiO₂ | 2 | 2 | 1 | 2 |
| | a4 | S1 | Mg | 0.01 | 0.10 | 1.9 | 1.9 | MgO | 6 | Al₂O₃ | 1 | SiO₂ | 1 | 3 | 1 | 2 |
| | a5 | S1 | Ca | 0.03 | 0.14 | 2.3 | 2.3 | CaO | 4 | Al₂O₃ | 1 | SiO₂ | 1 | 3 | 1 | 2 |
| | a6 | S1 | Ca | 0.005 | 0.20 | 2.6 | 2.5 | CaO | 0.003 | Al₂O₃ | 98 | SiO₂ | 1 | 2 | 1 | 2 |
| | a7 | S1 | Ca | 95 | 0.30 | 2.4 | 2.3 | CaO | 0.04 | Al₂O₃ | 98 | SiO₂ | 1 | 2 | 1 | 2 |
| | a8 | S1 | Ti | 27 | 0.005 | 2.0 | 2.0 | TiO₂ | 22 | Al₂O₃ | 35 | SiO₂ | 42 | 1 | 1 | 2 |
| | a9 | S4 | Ti | 20 | 50.0 | 0.9 | 0.9 | TiO₂ | 22 | Al₂O₃ | 35 | SiO₂ | 42 | 1 | 1 | 2 |

As in Invention Examples A1 to A57, when the A group element is included in the oxide film layer in a proportion in the range of the present invention, the coating material adhesiveness is excellent. As a result, the corrosion resistance after coating was also excellent. In addition, in Invention Examples A1 to A57, the A group element was concentrated in the surface layer area of the oxide film layer. Therefore, the pitting corrosion resistance was also excellent.

In contrast, in Comparative Example a1 which did not contain the A group element in the oxide film layer, and a2, a3, a6, a7, a8, and a9 in which the proportion of the A group element in the oxide film layer was outside the range of the present invention and/or the thickness of the oxide film layer was outside the range of the present invention, the coating material adhesiveness and/or the pitting corrosion resistance was poor. In addition, in a4 and a5, no particles were sprayed, and thus the A group element was not concentrated in the surface layer area of the oxide film layer, and the pitting corrosion resistance was poor.

TABLE 3

| | | | Al-Fe | | | | |
|---|---|---|---|---|---|---|---|
| | | | intermetallic | | | | |
| | | | compound | Oxide film layer | | | |
| | | | layer | | | | Detection |
| | | | Content | A | Proportion | | intensity |
| | | Steel | of Si | group | of element | Thickness | proportion 1 |
| | Symbol | No. | (mass %) | element | (atom %) | [um] | — |
| Invention | B1 | S1 | 3 | Sr | 1 | 0.1 | 3.18 |
| Example | B2 | S4 | 10 | Sr | 1 | 0.1 | 5.87 |
| | B3 | S7 | 20 | Sr | 1 | 0.1 | 4.12 |
| | B4 | S1 | 3 | Mg | 1 | 0.1 | 4.88 |
| | B5 | S4 | 10 | Mg | 1 | 0.1 | 7.49 |
| | B6 | S7 | 20 | Mg | 1 | 0.1 | 5.48 |
| | B7 | S4 | 15 | Mg | 3 | 0.1 | 6.78 |

| | | | | | | Characteristics | | |
|---|---|---|---|---|---|---|---|---|
| Compound configuring oxide film layer | | | | | | | Corrosion | |
| Compound (p) | | Compound (q) | | Compound (r) | | Coating | resistance | Pitting |
| Kind of | Proportion | Kind of | Proportion | Kind of | Proportion | material | after | corrosion |
| compound | (mass %) | compound | (mass %) | compound | (mass %) | adhesiveness | coating | resistance |
| SrO | 36 | Al₂O₃ | 57 | SiO₂ | 7 | 3 | 3 | 3 |
| SrO | 36 | Al₂O₃ | 51 | SiO₂ | 13 | 3 | 3 | 3 |
| SrO | 42 | Al₂O₃ | 43 | SiO₂ | 15 | 3 | 3 | 3 |
| MgO | 38 | Al₂O₃ | 55 | SiO₂ | 7 | 3 | 3 | 3 |
| MgO | 37 | Al₂O₃ | 51 | SiO₂ | 12 | 3 | 3 | 3 |
| MgO | 40 | Al₂O₃ | 45 | SiO₂ | 15 | 3 | 3 | 3 |
| MgAl₂O₄ | 18 | Al₂O₃ | 74 | SiO₂ | 8 | 3 | 3 | 4 |

In addition, in Invention Examples B1 to B7 shown in Table 3, the amount of Si in the plating bath was set to 8% or more, thereby controlling Si to be contained in the Al—Fe intermetallic compound.

As is clear from the results of Table 3, Invention Examples B1 to B7 had superior corrosion resistance after coating to Invention Example A27 in which not much Si was included in the Al—Fe intermetallic compound layer. This is considered to be because a Si oxide generated over time in the corrosion test had excellent water resistance and thus had an effect of suppressing corrosion. In all examples of B1 to B7, the thicknesses of the Al—Fe intermetallic compound layers were in a range of 0.1 to 10.0 μm.

The preferred embodiment of the present invention has been described above in detail, but it is needless to say that the present invention is not limited to such examples. It is clear that a person skilled in the art is able to conceive of a variety of modification examples or correction examples in the scope of the technical concept described in the claims, and obviously, these examples also belong to the technical scope of the present invention.

### INDUSTRIAL APPLICABILITY

According to the present invention, it is possible to provide a hot stamped member that has excellent adhesion to electrodeposition coating films (coating material adhesiveness) and pitting corrosion resistance. Therefore, the hot stamped member is highly industrially applicable.

### BRIEF DESCRIPTION OF THE REFERENCE SYMBOLS

1 STEEL
2 Al—Fe INTERMETALLIC COMPOUND LAYER
3 OXIDE FILM LAYER
10 PARTICLE
21 PLATED METAL (MOLTEN STATE)
22 PLATED METAL (SOLIDIFIED STATE)

1. A hot stamped member comprising:
a steel;
an Al—Fe intermetallic compound layer formed on the steel; and
an oxide film layer formed on the Al—Fe intermetallic compound layer,
wherein the oxide film layer comprises one or more A group elements selected from the group consisting of Be, Mg, Ca, Sr, Ba, Sc, Ti, V, Cr, Mn, Fe, Co, Ni, Cu, and Zn, Al, oxygen, and impurities,
a proportion of the A group element in the oxide film layer excluding the oxygen is 0.01 atom % or more and 80 atom % or less,
a thickness t of the oxide film layer is 0.1 to 10.0 μm, and
in the case of measuring the A group element in the oxide film layer in a thickness direction from a surface of the oxide film layer using a GDS, a maximum value of a detection intensity of the A group element in a range from the surface to one-third of the thickness t is 3.0 times or more an average value of detection intensities of the A group element in a range from two thirds of the thickness t to t.

2. The hot stamped member according to claim 1,
wherein the maximum value of the detection intensity of the A group element is 8.0 times or more the average value of the detection intensities of the A group element.

3. The hot stamped member according to claim 1,
wherein a component of the steel includes, by mass %,
C: 0.1% to 0.4%,
Si: 0.01% to 0.60%,
Mn: 0.50% to 3.00%,
P: 0.05% or less,
S: 0.020% or less,
Al: 0.10% or less,
Ti: 0.01% to 0.10%,
B: 0.0001% to 0.0100%,
N: 0.010% or less,
Cr: 0% to 1.0%, and
Mo: 0% to 1.0%
with a remainder of Fe and impurities.

4. The hot stamped member according to claim 3,
wherein the component of the steel includes, by mass %, any one or both of Cr: 0.01% to 1.0% and Mo: 0.01% to 1.0%.

5. The hot stamped member according to claim 1,
wherein the Al—Fe intermetallic compound layer includes Si.

6. The hot stamped member according to claim 2,
wherein a component of the steel includes, by mass %,
C: 0.1% to 0.4%,
Si: 0.01% to 0.60%,
Mn: 0.50% to 3.00%,
P: 0.05% or less,
S: 0.020% or less,
Al: 0.10% or less,
Ti: 0.01% to 0.10%,
B: 0.0001% to 0.0100%,
N: 0.010% or less,
Cr: 0% to 1.0%, and
Mo: 0% to 1.0%
with a remainder of Fe and impurities.

7. The hot stamped member according to claim 2,
wherein the Al—Fe intermetallic compound layer includes Si.

8. The hot stamped member according to claim 3,
wherein the Al—Fe intermetallic compound layer includes Si.

9. The hot stamped member according to claim 4,
wherein the Al—Fe intermetallic compound layer includes Si.
